(19) United States
(12) Patent Application Publication
(10) Pub. No.: US 2005/0174992 A1
(43) Pub. Date: Aug. 11, 2005

(54) Landline telephones converted to transmit and receive cell phones telecommunication

(76) Inventors: Ray G. Files, Carlsbad, CA (US); Darry L Boyd, San Diego, CA (US)

Correspondence Address: Darry L. Boyd, P. O. Box 261358, San Diego, CA, 92196, US

(21) Appl. No.: 10/775,776

(22) Filed: Feb. 9, 2004

(51) Int. Cl. H04L 12/66

(52) U.S. Cl. 370/352

(57) ABSTRACT

Cell Phone when brought in near proximity of a landline telephone will convert the landline telephone to unified system with the cell phone. When the cell phone in the general proximity of the programmable and control-switching, it will activate the programmable and control-switching device. When the cell phone ring it will ring the landline phone. The call can be answered by the landline telephone or the cell phone. A landline telephone line or service is not needed for the conversion to work. The system utilizes plastic encapsulated proximity circuit that is attached to the cell phone. A programmable base unit consists of power supply, security code circuit, programming circuit, frequency-programming switches to shut the modules on and off, cell phone and landline detection circuit, and a receiver and transmitter. The landline programmable device consists of power supply, frequency control switches, programming circuit, transmitter and receiver, landline or cell detection circuit, and landline telephone ringing circuit.

### BACKGROUND OF INVENTION

This invention relates to users utilizing landline telephones to transmit and receive cell phone telecommunication. Many people today do not need both a cell phone and landline telephone service. But the enjoy the comfort of talking on landline telephones. They would also enjoy not having to locate the cell phone when it rings. There are also possibilities of health effects associated with cellular usage. This invention allows the comfort of communicating on a landline telephone utilizing one number the cell number. The present invention relates to a programmable and switching control device for allowing a landline telephone to received calls when the cell phone is in general proximity of the programmable and switching control device. The present invention operates with a proximity circuit, security code circuit, and power supply, programming circuit for landline modules, frequency-switching circuit, and programmable modules. After programming is complete, when the cell phone is in general proximity of the control unit it will activate the landline telephone modules. The signal will be received directly by landline modules attached to landline phone. The user than can pickup the ringing landline phones.

### SUMMARY OF INVENTION

The primary object of the present invention is to provide user the convenience of using the landline telephone without the need to have landline telephone service. The cell phone will be used to activate landline phone for telecommunication utilizing the cell number or act in such manner that that cell phone or associated device(s) will activate both the cell and landline phone.

### BRIEF DESCRIPTION OF THE DRAWINGS

FIG. 1 is a block diagram showing the flow of the present invention,

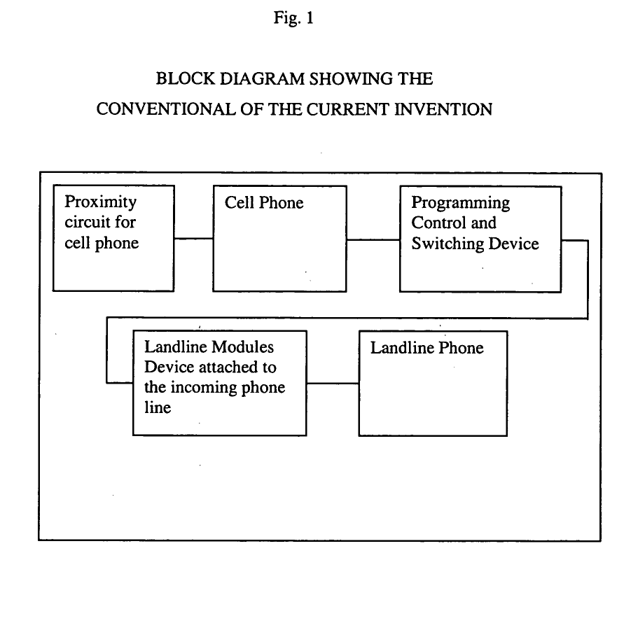

FIG. 2 is to illustrate that present invention has proximity circuit attached to outside shell of the cell phone or left unattached,

FIG. 3 is layout of the programmable and control-switching device,

FIG. 4 is layout of the landline programmable device.

### DETAILED DESCRIPTION OF THE PREFERRED EMBODIMENT

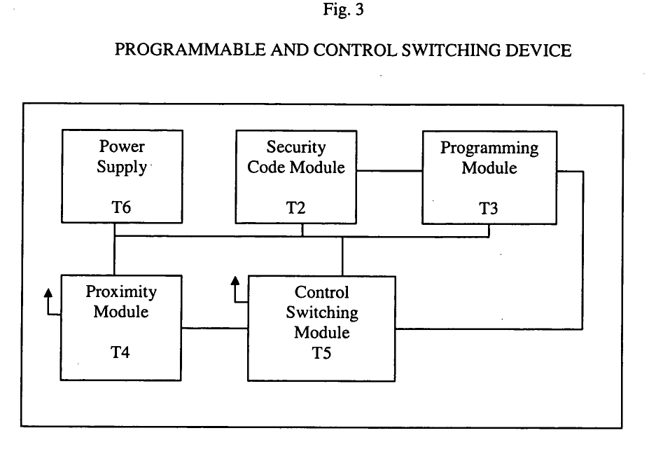

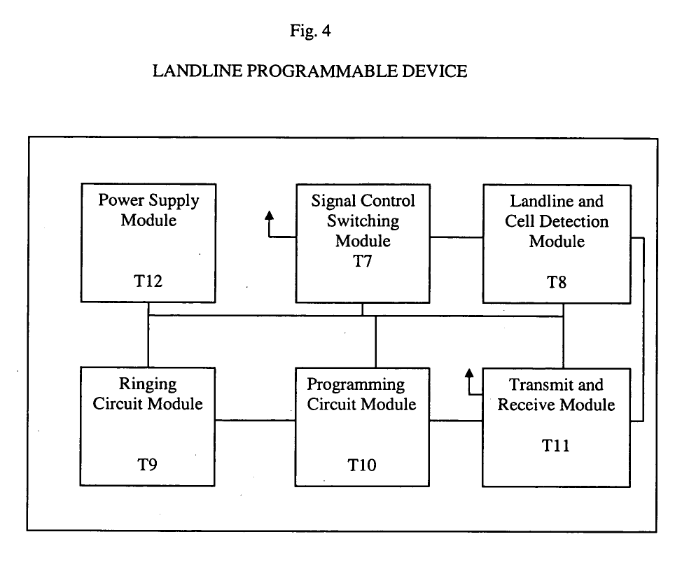

Referring to FIG. 3, the programmable control ands witching device has a security code-programming module. This is utilized before the landline programmable device can be programmed. Security code programming module T2 prevents two users from sharing the same landline programmable device FIG. 4 for additional privacy. The cell phone and landline programmable device are connected to programmable and control switching device FIG. 3. The related cell phones information in then entered into the programmable and control switching device FIG. 3 and the landline programmable device FIG. 4 is programmed. The landline programmable device is removed and hook to the incoming landline phone by a standard phone cable. The landline programmable device FIG. 4 is in between the landline and wall jack. Connection to the wall jack is not required.

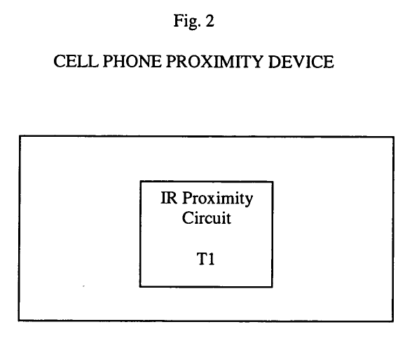

The small thin proximity device FIG. 2 is attached to cell phone. When the cell phone is located in the general proximity of the programmable and control-switching device FIG. 3 a signal is given to activate the landline programmable device FIG. 4 by the signal control-switching module T7. When an incoming call come in into landline programmable device FIG. 4 detects and display that it a landline or cell incoming call to the user.

When it is a landline signal, the landline and cell detection module T8 passes the voice signal ringing voltage direct to the landline. When it is a cell signal landline and cell T8 provide a signal to the ringing circuit module T9. The ringing circuit provides the adequate ring voltage to the landline phone. The landline phone rings. The landline and cell detection module T8 signal activates the transmit and receive module T11 to accept the incoming signal from the cellular provider. There is a switch provided for the user to choose between cell and the landline for outgoing calls.

1. Landline phones can be converted to transmit and receive cell phone telecommunication.

2. Landline phones can be converted to transmit and receive cell phone telecommunication without a landline service provider.

3. Landline phones can be converted to transmit and receive cell phone telecommunication with a landline service provider

4. Landline phones can be converted to transmit and receive cell phone telecommunication when an electronic device and cell phone are brought within general proximity of each other.

5. Landline phones can be converted to transmit and receive cell phone telecommunication with a switching circuit within the cell phone for activation.
